(19) United States
(12) Patent Application Publication
(10) Pub. No.: US 2008/0136983 A1
(43) Pub. Date: Jun. 12, 2008

(54) PIXEL STRUCTURE OF DISPLAY DEVICE AND METHOD FOR DRIVING THE SAME

(75) Inventor: Jih-Fon Huang, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: INDUSTRIAL TECHNOLOGY RESEARCH INSTITUTE, Hsinchu (TW)

(21) Appl. No.: 11/675,638

(22) Filed: Feb. 16, 2007

(30) Foreign Application Priority Data
Dec. 12, 2006 (TW) 95146390

(51) Int. Cl. G02F 1/1333; G09G 3/36

(52) U.S. Cl. 349/38; 345/87

(57) ABSTRACT

A pixel structure of a display device and a method for driving the same are provided. The pixel structure has a pixel capacitor, a switch, a pre-write unit and a reset unit. The pre-write unit is coupled to the switch for pre-writing display data therein when the switch is turned on. The reset unit is coupled between the pre-write unit and the pixel capacitor for resetting the pixel capacitor. When the pixel capacitor is reset, the display data is pre-written to the pre-write unit. After the pixel capacitor is reset and ready for display, the pre-written display data is written to the pixel capacitor.

### CROSS-REFERENCE TO RELATED APPLICATION

This application claims the priority benefit of Taiwan application serial no. 95146390, filed Dec. 12, 2006. All disclosure of the Taiwan application is incorporated herein by reference.

### BACKGROUND OF THE INVENTION

1. Field of the Invention

The present invention relates to a pixel structure of a display device and method for driving the same.

2. Description of Related Art

With the coming of the digital era, the rapid development of flat panel display market has lead to exceptionally fast growth of active flat panel liquid crystal displays such as home television, portable information products, notebook computers and digital cameras. Applications of these products have provided users with an easy and convenient lifestyle. Therefore, innovative methods of fabrication and related researches on thin film transistors are high on the developing list. The research of amorphous silicon technology focuses on demands of liquid crystal televisions with high resolution, high definition and large panel, and improvement of the characteristics of amorphous silicon thin film transistors is also required. In addition to reducing the RC delay due to conductive wires and parasitic capacitor, another development trends to lower the overall fabrication cost of the panel.

Furthermore, the fabrication cost of the rear stage process can be effectively reduced through a color sequential technique, for example, disclosed in U.S. Pat. No. 6,392,620, and the color saturation of the panel can be thus improved effectively. As a result, by introducing a new type back light module, the color saturation, the power saving and the reduction of the fabrication cost for the overall liquid crystal television panel can be significantly improved.

However, the display method of this new back light technique is to display three primary colors by using one pixel in a manner of time integration. To satisfy the display requirements of this technique, the thin film transistor has to reduce the charging time of a pixel capacitor to one-third (about 3˜4 μsec). Therefore, in order to drive the large size panel and the new color sequential back light, the charging time for the pixel capacitor must be reduced. Consequently, how to write a correct signal to a pixel capacitor with shortest time is currently one of the urgent problems to be solved.

### SUMMARY OF THE INVENTION

Accordingly, the present invention is directed to a pixel structure and provides a panel driving method featured with area-transfer for such pixel structure, so that a correct signal can be written to a pixel capacitor within a shorter period of time.

As embodied and broadly described herein, the invention provides a pixel structure for color sequential driving scheme. The pixel structure has a pixel capacitor, a switch, a pre-write unit and a reset unit. The pre-write unit is coupled to the switch for pre-writing display data therein when the switch is turned on. The reset unit is coupled between the pre-write unit and the pixel capacitor for resetting the pixel capacitor. When the pixel capacitor is reset, the display data is pre-written to the pre-write unit. After the pixel capacitor is reset and ready for display, the pre-written display data is written to the pixel capacitor.

The present invention also provides a method of driving a display panel. The panel has a plurality of pixels located at intersections between a plurality of scan lines and a plurality of data lines. The method of driving the display panel includes: a) setting the panel so that the display area of the panel includes at least a first display area and a second display area or more; b) resetting the pixels in the first display area, and driving to display the pixels in the second display area; c) writing image data to the first display area when resetting the pixels in the first display area; d) resetting the pixels in the second display area, and driving the pixels in the first display area to display the image data; and e) writing image data to the second display are when resetting the pixels in the second display area, and returning to step b).

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a timing diagram of a color sequential driving method.

FIG. 2A is a schematic diagram of a pixel structure corresponding to a capacitor on common electrode structure according to one embodiment of the present invention.

FIG. 2B is a variation example of the pixel structure in FIG. 2A.

FIG. 3A is a schematic diagram of another pixel structure corresponding to a capacitor on gate structure according to one embodiment of the present invention.

FIG. 3B is a variation example of the pixel structure in FIG. 3A.

FIGS. 4A and 4B are schematic diagrams of another pixel structure corresponding to a mixed configuration of capacitor on common electrode and capacitor on gate according to one embodiment of the present invention.

FIG. 5 is a flow diagram showing a driving method according to one embodiment of the present invention.

FIGS. 6A through 6H are diagrams showing examples of different panel area divisions.

FIG. 7 is a diagram showing a panel driving method according to an embodiment of the present invention.

FIG. 8 is a diagram showing a panel driving method according to another embodiment of the present invention.

FIG. 9 is a diagram showing a panel driving method according to another embodiment of the present invention.

FIGS. 10A through 10C are diagrams showing other panel driving methods according to another embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

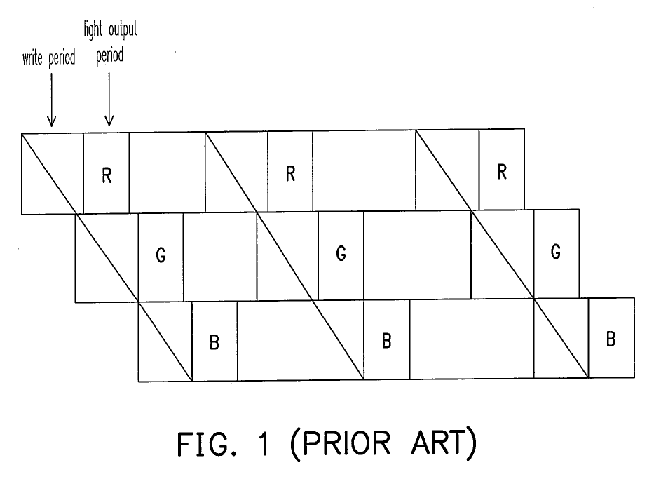

FIG. 1 is a timing diagram of a color sequential driving method. No color filter is used in this driving method, but three light sources including red (R), green (G) and blue (B) are used. In the embodiment of the present invention, the RGB color system is used in the description, but other color systems can be also used through a suitable modification. In FIG. 1, the locations marked with RGB labels indicate light output periods while the others are data write periods. Image data is displayed during the light output periods. As shown in FIG. 1, before the light output period for data R, data is first written to a storage capacitor of a pixel structure. As the data write period ends, i.e., data in form of charges is to charge the storage capacitor, the pixel starts to display the image data. While outputting the data R, data G corresponding to the green color is written to the pixel simultaneously. After outputting the data R, the data G can be outputted immediately. Similarly, data B corresponding to the blue color is written to the pixel simultaneously while outputting the data G. After outputting the data G, the data B is outputted immediately. In this way, pixels of the panel are driven to display through a color sequential scheme.

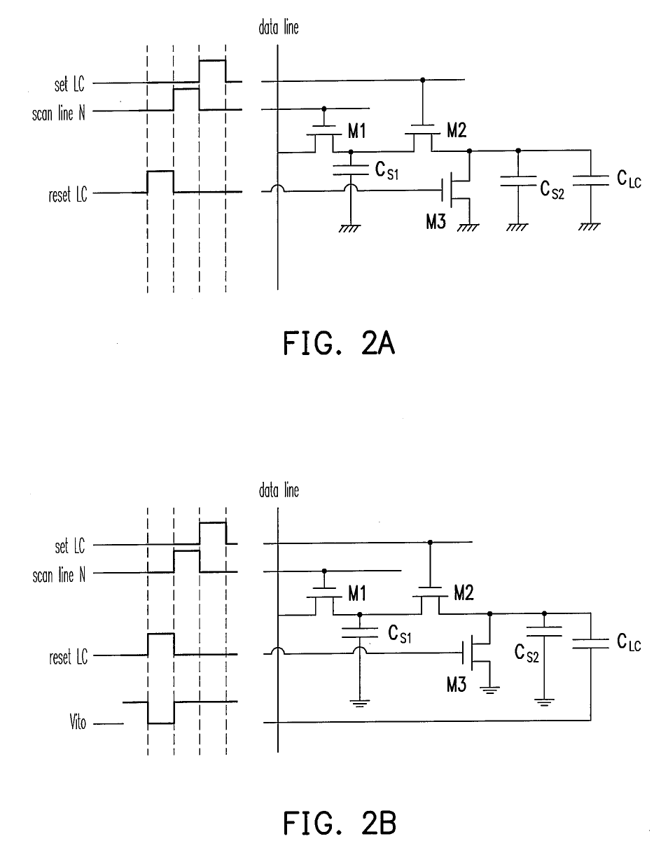

In addition to the color sequential driving scheme, the present invention further focuses on solutions for eliminating ghost image and providing an area driving (area transfer) method of the panel. First, the structure and the operating method of a single pixel are described. In the following embodiment, the method of driving a liquid crystal panel with the pixel structure is further described. According to the capacitor configuration, the present invention can be applied to capacitor on common electrode (Cs on common) and capacitor on gate (Cs on gate). FIG. 2A is a schematic diagram of a pixel structure corresponding to a structure for capacitor on common electrode according to one embodiment of the present invention.

The pixel structure of the present embodiment can comprise a pixel capacitor, a switch, a pre-write unit and a reset unit. Exemplary circuits based on this basic structure are provided as below. As shown in FIG. 2A, a pixel structure can comprise a first transistor M1 (switch), a first storage capacitor C_{S1}, and a second transistor M2 both serving as the pre-write unit, a second storage capacitor C_{S2} and a reset transistor M3 both serving as the reset unit and a pixel (liquid crystal) capacitor C_{LC}. The following embodiments also have the similar configuration. The foregoing transistors M1, M2 and M3 can be thin film transistors (TFTs), for example. In the embodiment, the liquid crystal capacitor of a liquid crystal display is used as an example; however, any display device that uses the color sequential driving method can use the method of the present invention. Therefore, the pixel capacitor is not limited to a liquid crystal capacitor. The gate of the first transistor M1 is electrically connected to a scan line (for example, the N^{th} scan line) and the source of the first transistor M1 is electrically connected to a data line. One end of the first storage capacitor C_{S1} is electrically connected to the drain of the first transistor M1 and the other end of the first storage capacitor C_{S1} is electrically connected to a pre-determined voltage (for example, a ground or a common electrode voltage). The source of the second transistor M2 is electrically connected to the drain of the first transistor M1 and the gate of the second transistor M2 is used as a set end of the liquid crystal pixel. One end of the second storage capacitor C_{S2} is electrically connected to the drain of the second transistor M2 and the other end of the second storage capacitor C_{S2} is electrically connected to the pre-determined voltage. The gate of the reset transistor M3 can receive a control signal for resetting the electric charges stored in the liquid crystal capacitor C_{LC}. The source of the reset transistor M3 is electrically connected to the drain of the second transistor M2 and the drain of the reset transistor M3 is electrically connected to the pre-determined voltage. In addition, the drain of the reset transistor M3 does not have to be electrically connected to the pre-determined voltage, for example, the drain can be electrically connected to a high frequency pulse signal (refer to subsequent embodiments).

Next, the method of driving the pixel structure in FIG. 2A is described with an example that the aforementioned pre-determined voltage is a ground voltage. Before driving the pixel, the electric charges previously stored is discharged, or for the liquid crystal display (LCD), the pixel capacitor can be charged to a common (middle) voltage Vcom. At this time, the liquid crystal (LC) reset signal will be applied to the gate of the reset transistor M3, and the LC rest signal can be a pulse signal, for example. At this time, both transistors M1 and M2 are turned off. When the LC reset signal is applied to the gate of the reset transistor M3, the reset transistor M3 is turned on. Because both transistors M1 and M2 are turned off and the drain of the transistor M3 is grounded, the two electrodes of the pixel capacitor C_{LC} are also grounded. Hence, the pixel capacitor C_{LC} can be completely discharged so that the electric charges previously stored are all discharged.

Next, a scan signal is applied to the gate of the transistor M1 so as to turn on the transistor M1. Therefore, image data from the data line can charge up the first storage capacitor C_{S1}. When the charging process is finished, the transistor M1 is turned off. Then, a liquid crystal (LC) setting signal is applied to the gate of the transistor M2 so as to turn on the transistor M2. At this time, the reset transistor M3 is turned off. Therefore, the electric charges stored in the first storage capacitor C_{S1} is able to charge up the second storage capacitor C_{S2} through the transistor M2 and the liquid crystal capacitor C_{LC} is also able to reach the same charge amount, so as to make the pixel display.

FIG. 2B is a variation example of the pixel structure in FIG. 2A. The main difference between the pixel structures in FIG. 2B and FIG. 2A is that the originally grounded end of the pixel capacitor C_{LC} is electrically connected to a transparent electrode voltage Vito. All the other structures are identical. Since the method of driving the pixel is also identical to the pixel structure in FIG. 2A, a detailed description is omitted.

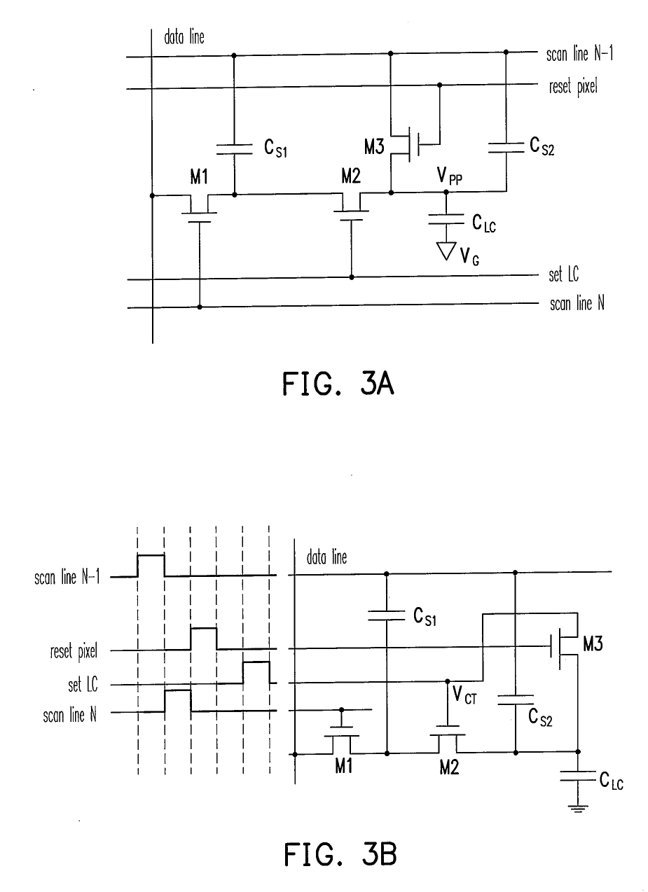

FIG. 3A is a schematic diagram of another pixel structure corresponding to a structure for capacitor on gate according to one embodiment of the present invention. The main difference between the pixel structures in FIG. 3A and FIG. 3B is that the originally grounded ends of the two storage capacitors C_{S1} and C_{S2} are electrically connected to a previous scan line. In addition, the originally grounded drain of the reset transistor M3 is electrically connected to the previous scan line.

The Q value (charges) of the first storage capacitor C_{S1} is determined according to the low voltage level of the previous scan line N−1. Before turning on the N^{th} scan line, the voltage of the N−1th scan line will vary. When the first transistor M1 is turned on and after the first storage capacitor C_{S1} is set (charged) to the required voltage, that is, after being charged to a data voltage Vdata to be written into, the voltage level of the N−1^{th} scan line will no longer change. Until all scan lines are completely scanned, the voltage of the N−1^{th} scan line is set to the common voltage Vcom. Thereafter, the reset transistor M3 is turned on. Since the voltage of the N−1^{th} scan line has been previously set to the common voltage Vcom, the node Vpp is set to the common voltage Vcom. Hence, the two electrodes of the pixel capacitor C_{LC} are set to the common voltage Vcom so that the pixel capacitor C_{LC} can be fully discharged and the image data of the previous frame can be cleared. After that, the voltage of the N−1^{th} scan line is set to the original voltage value. Next, the LC setting signal is applied to the second transistor M2 to turn on the second transistor M2. At this time, the reset transistor M3 is turned off. Therefore, the image data signal (charges) previously written into the first storage capacitor C_{S1} can charge the second storage capacitor C_{S2} and the liquid crystal capacitor C_{LC} so as to drive the pixel to display an image.

FIG. 3B is a variation example of the pixel structure in FIG. 3A. The drain of the reset transistor M3 is electrically connected to the gate of the second transistor M2. In FIG. 3B, the liquid crystal capacitor C_{LC} is reset when the reset transistor M3 is turned on. At this time, it has to make sure that the transistor M2 is turned off. Afterwards, the reset transistor M3 is turned off and then the voltage V_{CT} is increased to turn on the second transistor M2 for transferring electric charges to the second storage capacitor C_{S2} and the liquid crystal capacitor C_{LC} so as to drive the pixel to display an image.

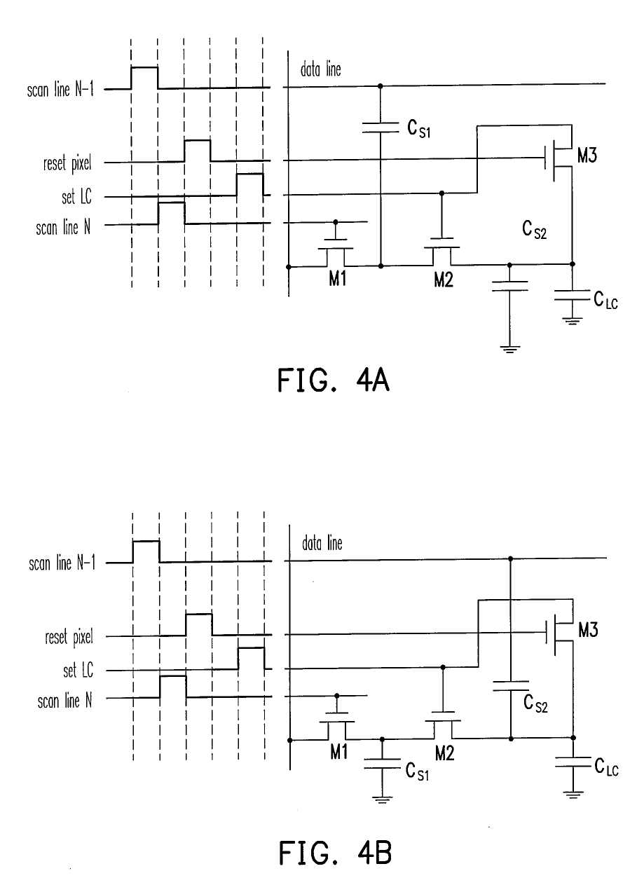

FIGS. 4A and 4B are schematic diagrams of another pixel structure corresponding to a mixed configuration of capacitor on common electrode and capacitor on gate according to one embodiment of the present invention. The main difference between the pixel structures in FIGS. 4A and 4B and the pixel structures in FIGS. 2A and 2B is the connection manner of the storage capacitor. Furthermore, in FIG. 4A, the originally grounded end of the first storage capacitor C_{S1}, is electrically connected to the previous scan line while the connection of the second storage capacitor C_{S2} is maintained the same. In FIG. 4B, the originally grounded end of the second storage capacitor C_{S2} is electrically connected to the previous scan line while the connection of the first storage capacitor C_{S1}, is maintained the same. Since the method of driving the pixel structures in FIGS. 4A and 4B is fundamentally identical to the method of driving the pixel structure in FIG. 2A, a detailed description is omitted.

The driving method of the present invention is based on the concept of area transfer. For example, the panel can be divided into two areas, in which one area is driven first and then another area is driven after that. With such conception, the panel can be divided into a plurality of areas according to different implementations. examples are provided as follows.

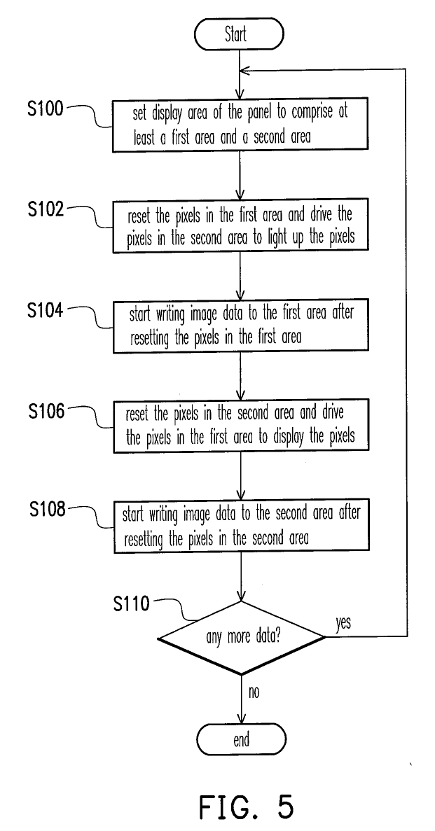

FIG. 5 is a flow chart showing a driving method according to one embodiment of the present invention. The display area of the panel comprises a plurality of pixels, and the pixels are located at intersections of a plurality of scan lines and a plurality of data lines. Each one of the pixel structures can be any one of the pixel structures as shown in FIG. 2A to FIG. 4B or some others. FIG. 2A is used as an example in the following description. First, in step S100, when designing the method of driving the panel, the number of areas in the panel must be determined. In the present embodiment, the panel can be divided into areas including at least a first display area and a second display area, or more display areas. Dividing the panel into the first and the second areas is based on the scan lines, the data lines or both. A more detailed description of the methods of division and examples is described below.

In step S102, the pixels in the first display area are reset and the pixels in the second display area are driven. Here, when the second display area displays image data, the pixel capacitors of all the pixel structures in the first display area can be reset. In other words, the electric charges within the pixel capacitors are discharged so that no residual image will remain in the display image of the next frame. For example, as shown in FIG. 2A, the transistor M3 is reset so that the pixel capacitor C_{LC} is discharged.

In step S104, after all the pixels in the first display area have been reset, image data can be written to the first display area. For example, as shown in FIG. 2A, the image data pass through the transistor M1 to charge the first storage capacitor C_{S1}, so that the first storage capacitor C_{S1}, has a voltage level corresponding to the image data.

In step S106, after displaying the image data in the second display area, the pixel capacitors of the pixels are immediately reset. For example, the image data (voltage) written into the first storage capacitors C_{S1} of the first area charges the pixel capacitors to display image data. For example, as shown in FIG. 2A, the transistor M2 is turned on while the reset transistor M3 is turned off, so that the voltage of the first storage capacitor C_{S1} can charge the pixel capacitor C_{LC}.

In step S108, after displaying the pixels in the first display area and resetting the pixels in the second display area, image data can be continuously written into the first storage capacitor C_{S1}, of each pixel structure corresponding to the second display area. In step S110, whether or not the image data is continuously inputted is determined. If the image data is still inputted, then the steps S102 to S108 are repeated to continuously drive the panel to display images.

Therefore, in the basis of the above method, the entire display panel can be driven by using the area transfer method. Furthermore, only slight modification of the timing is require when the panel is divided into more than two display areas in step S100.

Furthermore, the operations of the first display area and the second display area can be overlapped (reset and display operations) as long as these two areas operate in different steps. In addition, to reset and perform area transfer of the pixels, all the pixels in the panel can be reset together. Thereafter, according to a selected sequence for the area transfer, image data are respectively displayed on each of the display areas. Thus, the transient current can be reduced so as to save electrical power.

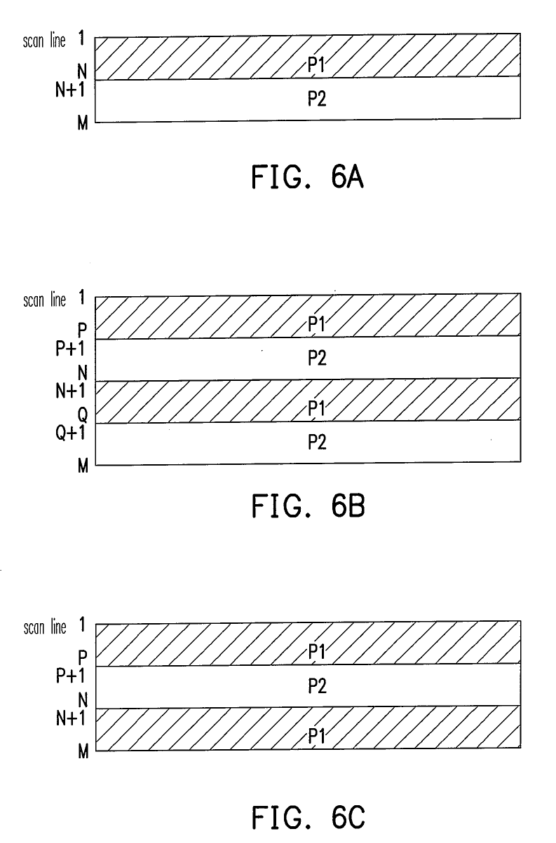

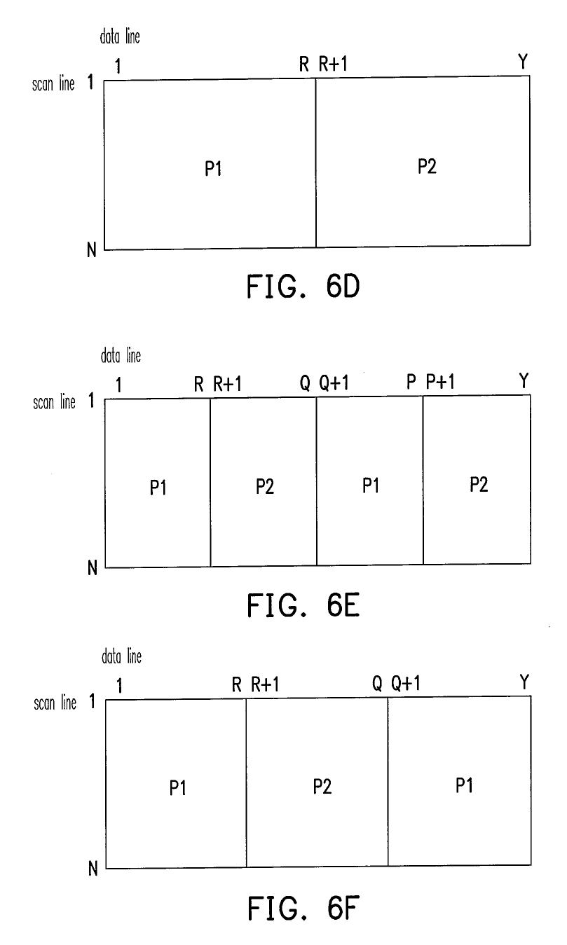

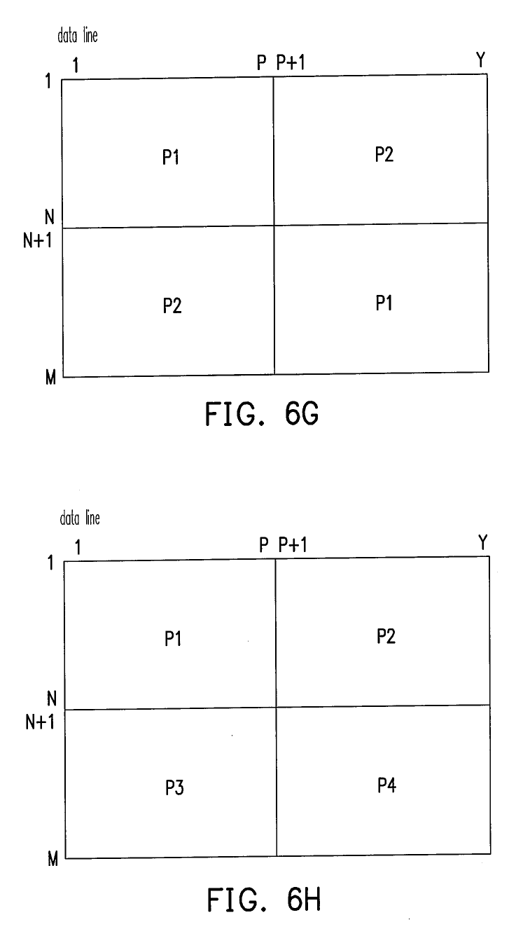

FIGS. 6A through 6H show examples of different area divisions of the panel. In FIG. 6A, the panel is divided into two areas P1 and P2 based on scan lines, in which the area P1 covers all pixels from the first to the N^{th} scan lines and the area P2 covers all pixels from the N+1^{th} to the M^{th} scan lines. In FIG. 6B, the panel is divided into four areas also based on to scan lines, but the areas P1 and P2 are separated into two non-consecutive areas. The areas P1 cover all pixels from the first to the P^{th} scan lines and the N+1^{th} to the Q^{th} scan lines, and the areas P2 cover all pixels from the P+1^{th} to the N^{th} scan lines and the Q+1^{th} to the M^{th} scan lines. In FIG. 6C, the panel is divided into three areas based on scan lines, i.e., two areas P1 and one P2 area. The areas P1 cover all pixels from the first to the P^{th} scan lines and the N+1^{th} to the M^{th} scan lines, and the area P2 covers all the pixels from the P+1^{th} to the N^{th} scan lines. The foregoing divisions are only examples. In practice, suitable adjustment can be made according to the requirements.

FIGS. 6D, 6E and 6F show other examples of panel area divisions. In these examples, the areas are divided based on data lines. In FIG. 6D, the panel is divided into two areas P1 and P2 based on data lines. The area P1 covers all pixels from the first to the R^{th} data lines, and the area P2 covers all pixels from the R+1^{th} to the Y^{th} data line. In FIG. 6, the panel is divided into four areas. The areas P1 cover all pixels from the first to the R^{th} data lines and the Q+1^{th} to the P^{th} data lines, and the areas P2 cover all pixels from the R+1^{th} to the Q^{th} data lines and the P+1^{th} to the Y^{th} data lines. In FIG. 6F, the panel is divided into three areas, two areas P1 and one area P2. The P1 areas cover all pixels from the first to the R^{th} data lines and the Q+1^{th} to the Y^{th} data lines, and the area P2 covers all pixels from the R+1^{th} to the Q^{th} data lines. The foregoing divisions are only examples. In practice, suitable adjustment can be made according to the requirements.

FIGS. 6G and 6H show other examples of panel area divisions. The areas in these examples are divided based on scan lines and data lines. In FIG. 6G, the panel is divided into two P1 areas and two P2 areas. The areas P1 cover all pixels in the area from the first to the P^{th} data lines and the first to the N^{th} scan lines as well as the area from the P+1^{th} to the Y^{th} data lines and the N+1^{th} to the M^{th} scan lines. The areas P2 cover all pixels in the area from the first to the P^{th} data lines and the N+1^{th} to the M^{th} scan lines as well as the area from the P+1^{th} to the Y^{th} data lines and the first to the N^{th} scan lines. In FIG. 6H, the panel is divided into four areas P1, P2, P3 and P4. The area P1 covers all pixels from the first to the P^{th} data lines and the first to the N^{th} scan lines; the area P2 covers all pixels from the P+1^{th} to the Y^{th} data lines and the first to the N^{th} scan lines; the area P3 covers all pixels from the first to the P^{th} data lines and the N+1^{th} to the M^{th} scan lines; the P4 area covers all pixels from the P+1^{th} to the Y^{th} data lines and the N+1^{th} to the M^{th} scan lines. The foregoing divisions are only examples. In practice, the number of divided areas and the type of areas, etc. can be suitably adjusted according to the requirements.

When driving the panel, for example, when all pixels in the area P2 are driven to display an image, all pixels in the area P1 are reset and then the process of writing data is initiated. After driving the pixels in the area P2, the pixels in the area P2 are reset (i.e., reset the pixel capacitor). At this time, the pixels in the area P1 can be driven. A detailed description of the driving timing of each pixel can be referred to FIG. 2A to FIG. 4B.

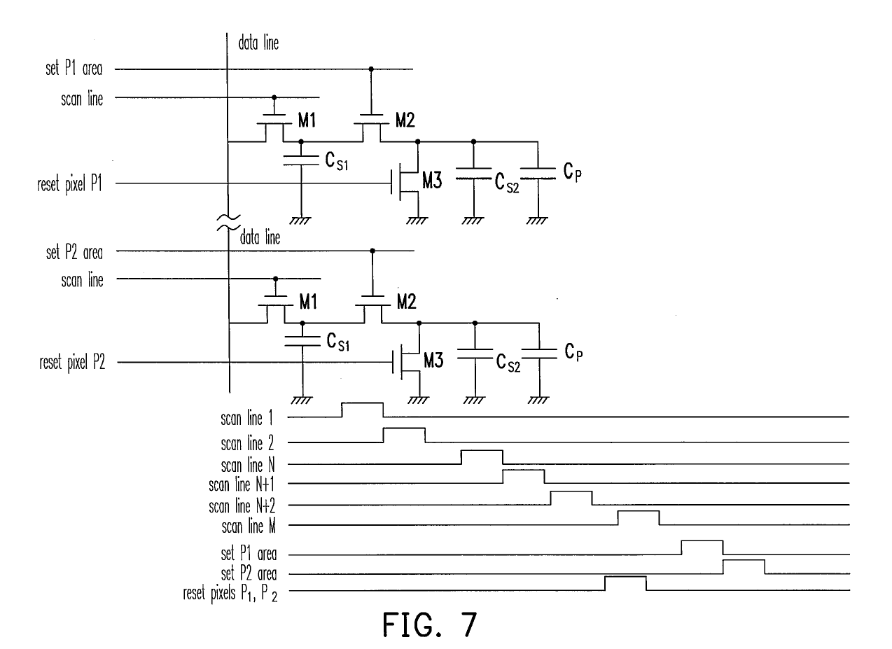

FIG. 7 is a diagram showing a panel driving method according to an embodiment of the present invention. In the example shown in FIG. 7, the pixels in the panel is divided into two areas P1 and P2 corresponding to the area divisions shown in FIG. 6. The pixel structure in FIG. 7 only shows one of the pixels in either the area P1 or the area P2. For example, in the pixels corresponding to the P1 area (the upper diagram), the scan lines for resetting the pixels or setting the pixel are the first to the N^{th} scan lines (all pixels in the area P1 in FIG. 6A). In the pixels corresponding to the P2 area (the middle diagram), the scan lines for resetting the pixels or setting the pixel are the N+1^{th} to the M^{th} scan lines (all the pixels in the area P2 in FIG. 6A). The timing for driving the pixel structures is shown in the lower part of FIG. 7 and the method of driving the pixel structures is described in FIG. 2A. Therefore, in the embodiment of FIG. 7, the panel is divided into two adjacent areas. When the display area P2 displays an image, the pixel capacitors in the P1 area can be reset and data can be pre-written into the first storage capacitor of the area P1.

Furthermore, the upper part of the timing diagram in FIG. 7 describes that the can lines are turned on in sequence and the lower part of the timing diagram describes that the timing relationships between setting and resetting pixel. In other words, it is not necessary that there exists a sequential timing relation between the upper and lower parts. According to the timing relation diagram for setting and resetting the pixel, pixel setting is carried out (i.e., performing the area transfer) after pixel resetting. However, the time point for resetting the pixel does not have to be prior to that the scan line M is turned on. The pixel resetting can be carried out after the scan line M is turned on. Similarly, the representations for the timing diagram in the following figures are also the same. In addition, setting the area P2 does not have to be right after the area P1 is set. In other words, the transfer operation on the area P2 can begin while the P1 area is still in the area transfer operation.

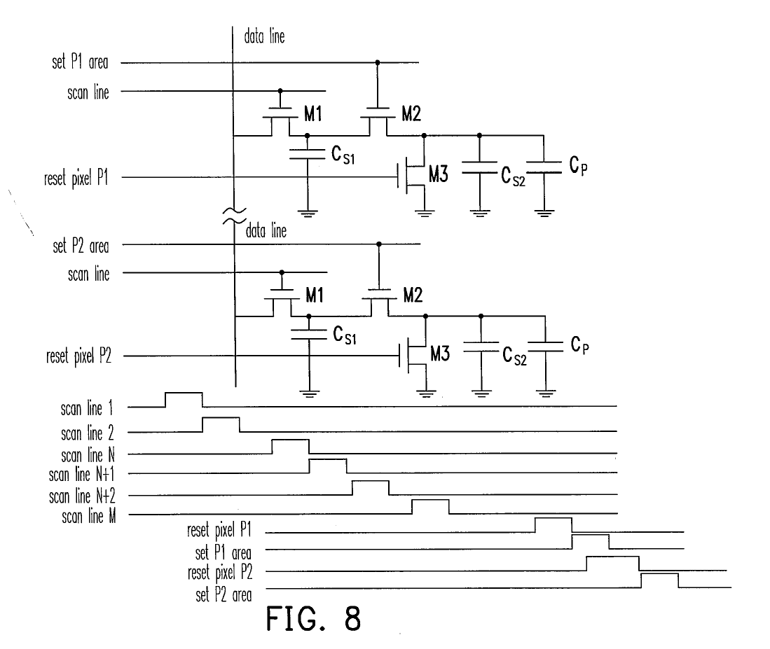

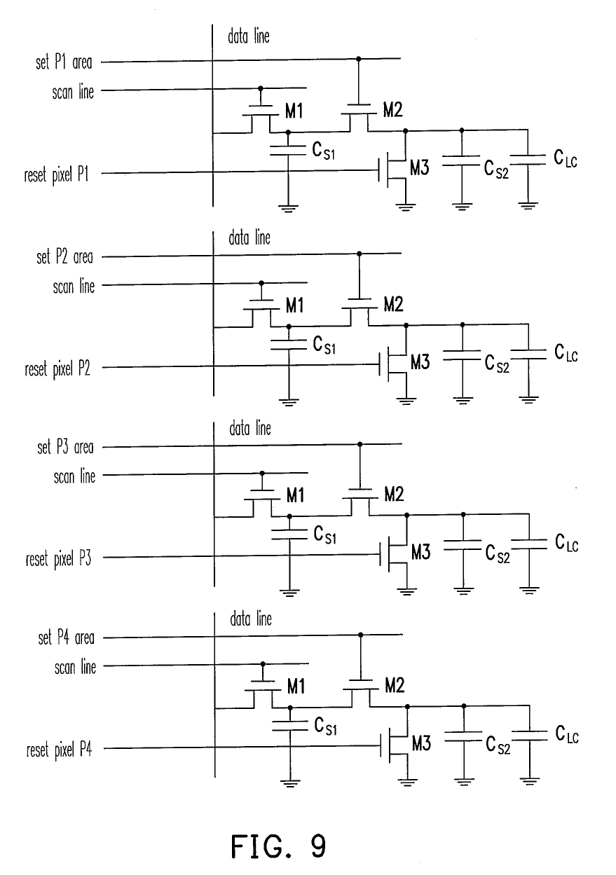

FIG. 8 is a diagram showing a panel driving method according to another embodiment of the present invention. The panel in this example is divided into two areas P1 and P2 and the area division corresponds to FIG. 6B. Since the driving method is similar to FIG. 7, a detailed description is omitted. In the present example, the areas P1 and the P2 are alternately disposed. FIG. 9 is a diagram showing a panel driving method according to another embodiment of the present invention. The panel in this example is divided into four areas P1, P2, P3 and P4 and the area division corresponds to FIG. 6H. According to the examples in FIGS. 6A through 6H and together with suitable timing and the aforementioned pixel driving methods, the area transfer panel driving method of the present invention can be achieved. In addition, FIGS. 7 and 8 use a capacitor on common electrode structure as an example. However, the foregoing pixel structures to can be changed to any one of the foregoing structures described in FIGS. 2B to 4 and driving the pixels with a corresponding timing.

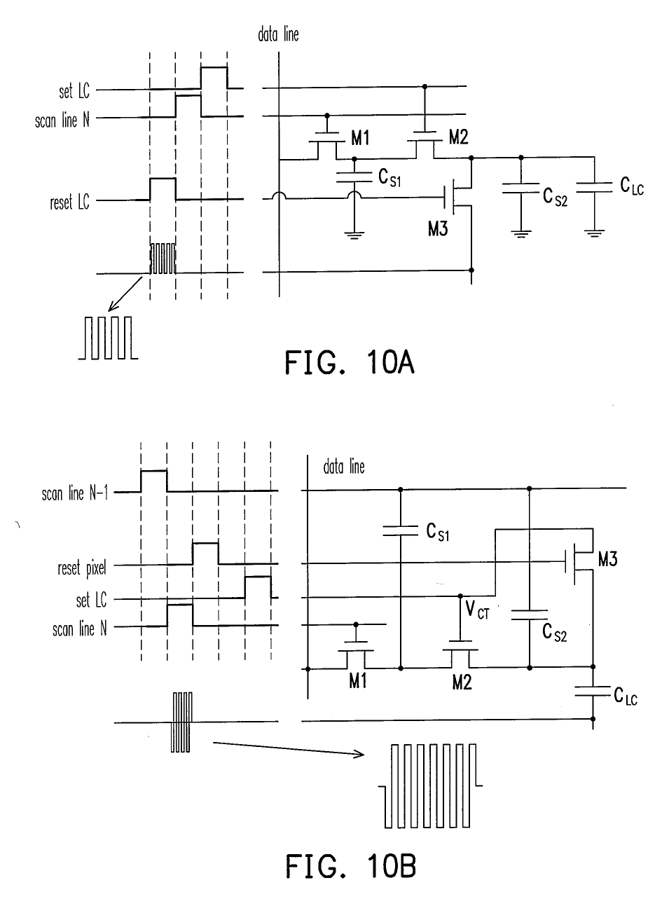

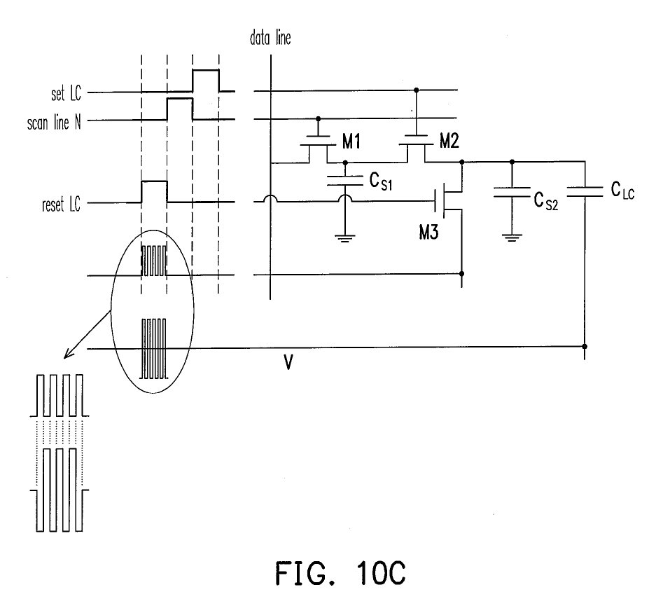

FIGS. 10A through 10C are diagrams showing other panel driving methods according to another embodiment of the present invention. The panel driving methods in FIGS. 10A through 10C can be considered as variations of the foregoing embodiments. Since the area transfer of the driving method is identical to the foregoing embodiments, only their differences are described.

As shown in FIG. 10A, the main point in the present embodiment is that a high frequency signal is simultaneously applied to the drain of the reset transistor M3 when the reset signal is applied to the gate of the reset transistor M3 to reset the pixel. The high frequency signal has a frequency between 10 kHz to 50 kHz, for example. When this high frequency signal is applied, the liquid crystal molecules will be heated so that the liquid crystal molecules can rotate faster and hence have a faster response speed. Furthermore, the high frequency signal does not have to be a constant frequency. The high frequency signal may be modified using a suitable feedback loop based on the external temperature so that the operating frequency can be changed in a timely manner. Moreover, the pulse number of high frequency signal can be varied according to the feedback temperature of the display medium. For example, a frequency of 50 kHz is applied at 0° C. but is lowered to 20 kHz at 25° C. No high frequency signal is applied when the temperature reaches 50° C. In other words, the frequency or the pulse number can be increased when the temperature of the display medium decreases so as to increase the response speed of the liquid crystal molecules.

In addition, as shown in FIG. 10B, the high frequency signal can be applied to one end of the liquid crystal capacitor C_{LC} to achieve the same effect. In the structure shown in FIG. 10C, the high frequency signal is simultaneously applied to the drain of the reset transistor M3 and one end of the liquid crystal capacitor C_{LC} when the pixel is reset. Consequently, a greater voltage differential is provided to increase the response speed of the liquid crystal molecules. Furthermore, when high frequency signals are simultaneously applied to the reset transistor M3 and the liquid crystal capacitor C_{LC}, the high frequency signals preferably have to be out of phase so as to maximize their voltage difference.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A pixel structure, suitable for a color sequential driving scheme, comprising:
a pixel capacitor;
a switch;
a pre-write unit, coupled to the switch for pre-writing display data to the pre-write unit when the switch is turned on; and
a reset unit, coupled between the pre-write unit and the pixel capacitor for resetting the pixel capacitor,
wherein the display data is pre-written to the pre-write unit when the pixel capacitor is reset, and the display data is asynchronously written to the pixel capacitor after the pixel capacitor has been reset and ready for displaying the display data.

2. The pixel structure of claim 1, wherein the switch is a first transistor having a gate, a source and a drain, wherein the gate is electrically connected to a scan line and the source is electrically connected to a data line.

3. The pixel structure of claim 2, wherein the pre-write unit further comprises:
a first storage capacitor having one end electrically connected to the drain of the first transistor and another end electrically connected to a pre-determined voltage; and
a second transistor having a gate, a source and a drain, wherein the gate receives a pixel set signal and the source is electrically connected to the drain of the first transistor.

4. The pixel structure of claim 3, wherein the reset unit further comprises:
a second storage capacitor having one end electrically connected to the drain of the second transistor and one end of the pixel capacitor and another end connected to the pre-determined voltage; and
a third transistor having a gate, a source and a drain, wherein the gate receives a pixel reset signal and the source is electrically connected to the drain of the second transistor.

5. The pixel structure of claim 4, wherein the first, the second and third transistors are thin film transistors.

6. The pixel structure of claim 3, wherein the pre-determined voltage is a ground voltage or a common voltage.

7. The pixel structure of claim 3, wherein the drain of the third transistor is connected to the pre-determined voltage.

8. The pixel structure of claim 2, wherein the pre-write unit further comprises:
a first storage capacitor having one end electrically connected to the drain of the first transistor and another end electrically connected to a previous scan line;
a second transistor having a gate, a source and a drain, wherein the gate receives a pixel set signal and the source is electrically connected to the drain of the first transistor.

9. The pixel structure of claim 8, wherein the reset unit further comprises:
a second storage capacitor having one end electrically connected to the drain of the second transistor and one end of the pixel capacitor and another end electrically connected to the previous scan line;
a third transistor having a gate, a source and a drain, wherein the gate receives a pixel reset signal, the source is electrically connected to the drain of the second transistor, and the drain is electrically connected to the gate of the second transistor or the previous scan line.

10. The pixel structure of claim 9, wherein the first, second and third transistors are thin film transistors.

11. The pixel structure of claim 2, wherein the pre-write unit further comprises:
a first storage capacitor having one end electrically connected to the drain of the first transistor;
a second transistor having a gate, a source and a drain, wherein the gate receives a pixel set signal and the source is electrically connected to the drain of the first transistor.

12. The pixel structure of claim 2, wherein the rest unit further comprises:
a second storage capacitor having one end electrically connected to the drain of the second transistor and one end of the pixel capacitor, wherein another end of the first storage capacitor is electrically connected a previous scan line and another end of the second storage capacitor is connected to a pre-determined voltage, or another end of the first storage capacitor is electrically connected to the pre-determined voltage and another end of the second storage capacitor is electrically connected to the previous scan line; and
a third transistor having a gate, a source and a drain, wherein the gate receives a pixel reset signal, the source is electrically connected to the drain of the second transistor and the drain electrically connected to the gate of the second transistor.

13. The pixel structure of claim 12, wherein the pre-determined voltage is a ground voltage or common electrode voltage.

14. The pixel structure of claim 12, wherein the first transistor, the second transistors and the reset transistor are thin film transistors.

15. The pixel structure of claim 1, wherein the reset unit is connected to a high frequency signal.

16. The pixel structure of claim 15, wherein the high frequency signal has a frequency between about 10 kHz to 50 kHz.

17. The pixel structure of claim 1, wherein another end of the pixel capacitor is connected to a high frequency signal.

18. The pixel structure of claim 17, wherein the high frequency signal has a frequency between about 10 kHz to 50 kHz.

19. The pixel structure of claim 1, wherein the reset unit and another end of the pixel capacitor are connected to a high frequency signal.

20. The pixel structure of claim 19, wherein the high frequency signal has a frequency between about 10 kHz to 50 kHz.

21. The pixel structure of claim 1, wherein another end of the pixel capacitor is connected to a pre-determined voltage or a transparent electrode voltage.

22. The pixel structure of claim 21, wherein the pre-determined voltage is a ground voltage or a common electrode voltage.

23. The pixel structure of claim 1, wherein the pixel capacitor is a liquid crystal capacitor.

24. A method of driving a display panel comprising a plurality of pixels located at intersections between a plurality of scan lines and a plurality of data lines, comprising steps of:
a) setting the panel in a manner that a display area of the panel at least comprises a first display area and a second display area or more;
b) resetting the pixels in the first display area and driving the pixels in the second display area to display;
c) writing an image data to the first display area after resetting the pixels in the first display area;
d) resetting the pixels in the second display area and driving the pixels in the first display area to display the image data; and
e) writing an image data to the second display area after resetting the pixels in the second display area, and returning to step b).

25. The driving method of claim 24, wherein the step a) also comprises: dividing the first and the second display areas according to the scan lines.

26. The driving method of claim 24, wherein the step a) also comprises: dividing the first and the second display areas according to the data lines.

27. The driving method of claim 24, wherein the step a) also comprises: dividing the first and the second display areas according to the scan lines and the data lines.

28. The driving method of claim 24, wherein the step a) also comprises: dividing the first and/or the second display area into a plurality of display areas.

29. The driving method of claim 28, wherein the step a) also comprises: arranging each of the display areas of the first and the second display areas adjacent to each other.

30. The driving method of claim 24, wherein the step a) also comprises: arranging the display areas of the first display area and each of the display areas of the second display area alternately.

31. The driving method of claim 24, wherein the step of resetting the first display area overlaps in time with the step of resetting the second display area.

32. The driving method of claim 24, wherein the step of displaying the first display area overlaps in time with the step of displaying the second display area.

33. The driving method of claim 24, wherein the pixels are liquid crystal pixels.

34. A method of driving a display panel comprising a plurality of pixels located at intersections between a plurality of scan lines and a plurality of data lines, comprising the steps of:
setting the panel by dividing the panel into a plurality of display areas;
resetting all the pixels in the panel;
writing an image data to each of the display areas; and
displaying the image data in each of the display areas according to an area sequence.

35. The driving method of claim 34, further comprising step of: dividing each of the display areas according to the scan lines.

36. The driving method of claim 34, further comprising step of: dividing each of the display areas according to the data lines.

37. The driving method of claim 34, further comprising step of: dividing each of the display areas according to the scan lines and the data lines.

38. The driving method of claim 34, wherein the pixels are liquid crystal pixels.
